(19) United States
(12) Patent Application Publication
(10) Pub. No.: US 2014/0095785 A1
(43) Pub. Date: Apr. 3, 2014

(54) Content Aware Block Power Savings

(71) Applicant: Bindiganavale NATARAJ, Cupertino, CA (US)

(72) Inventor: Bindiganavale NATARAJ, Cupertino, CA (US)

(73) Assignee: Broadcom Corporation, Irvine, CA (US)

(21) Appl. No.: 13/631,412

(22) Filed: Sep. 28, 2012

(51) Int. Cl. G06F 12/00

(52) U.S. Cl. 711/108; 711/154; 711/E12.001

(57) ABSTRACT

A memory architecture power savings system includes a first memory module configured to provide data corresponding to a stored address from among a plurality of stored addresses by comparing the plurality of stored addresses to a search key in response to a control signal. A second memory module is configured to store a plurality of data entries corresponding to truncated portions of the plurality of stored addresses, and to generate the control signal by comparing the plurality of data entries to a truncated portion of the search key.

### FIELD OF DISCLOSURE

The present disclosure relates generally to memory and specifically to content addressable memory (CAM).

### BACKGROUND

Content addressable memory (CAM) and ternary content addressable memory (TCAM) devices are frequently used in network switching and routing applications to determine forwarding destinations for data packets, and to provide more advanced network Quality of Service (QoS) functions such as traffic shaping, traffic policing, and rate limiting. More recently, CAM and TCAM devices have been deployed in network environments and processor cache applications to perform deep packet inspection tasks and execute processor instructions and operations quickly.

Both a CAM and a TCAM device can be instructed to compare a data string with data stored in an array as either CAM or TCAM data within the respective device. During a compare operation in a CAM, a search key is provided to the respective CAM array and can be compared with the CAM data stored therein. During a compare operation in a TCAM, a search key is provided to the TCAM array and can be compared to either the TCAM data stored therein or another value which can result in a match, no match, or a “don't care” condition whereby part of the TCAM data can be ignored. If a match is found between the search key and the CAM or TCAM data, the corresponding data can be associated with various operations such as network data packet operation. Exemplary network operations include a “permit” or “deny” according to an Access Control List (ACL), values for QoS policies, or a pointer to an entry in the hardware adjacency table that contains a next-hop MAC rewrite information in the case of a CAM or a TCAM used for IP routing, or a cache tag associated with a cache line in the case of a CAM or a TCAM used for processing cache data retrieval.

CAM and TCAM devices perform compare operations between the search key and the CAM/TCAM data virtually simultaneously, and therefore are advantageously fast albeit complex and expensive. The consistent compare operations executed by CAMs and/or TCAMs in an network system, therefore, utilize a great deal of power and represent both a significant source of power consumption and overall cost of a network or processor architecture.

What is needed, therefore, is a memory architecture which can provide reliable and cost-efficient operation while providing a power savings compared to the operation of a traditional CAM and/or TCAM system.

### BRIEF DESCRIPTION OF THE DRAWINGS/FIGURES

FIG. 1 illustrates a block diagram of a content aware block power savings architecture according to an exemplary embodiment of the disclosure;

FIG. 2 illustrates a memory module storage and compare operation according to an exemplary embodiment of the disclosure;

FIG. 3 is a flowchart illustrating a memory module operation during a KBP compare instruction according to an exemplary embodiment of the disclosure;

FIG. 4 is a flowchart illustrating a memory module write operation according to an exemplary embodiment of the disclosure; and

FIG. 5. illustrates a compaction routine in accordance with an embodiment of the disclosure.

The disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE DISCLOSURE

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described can include a particular feature, structure, or characteristic, but every exemplary embodiment can not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

Although the description of the present disclosure is to be described in terms of content-addressable memory (CAM) power savings, those skilled in the relevant art(s) will recognize that the present disclosure can be applicable to other storage media that match are capable of matching a search string to a correlated data string without departing from the spirit and scope of the present disclosure. For example, although the present disclosure is to be described using CAM and TCAM capable devices, those skilled in the relevant art(s) will recognize that functions of these devices can be applicable to other memory devices that use random access memory (RAM) and/or read-only memory (ROM) without departing from the spirit and scope of the present disclosure.

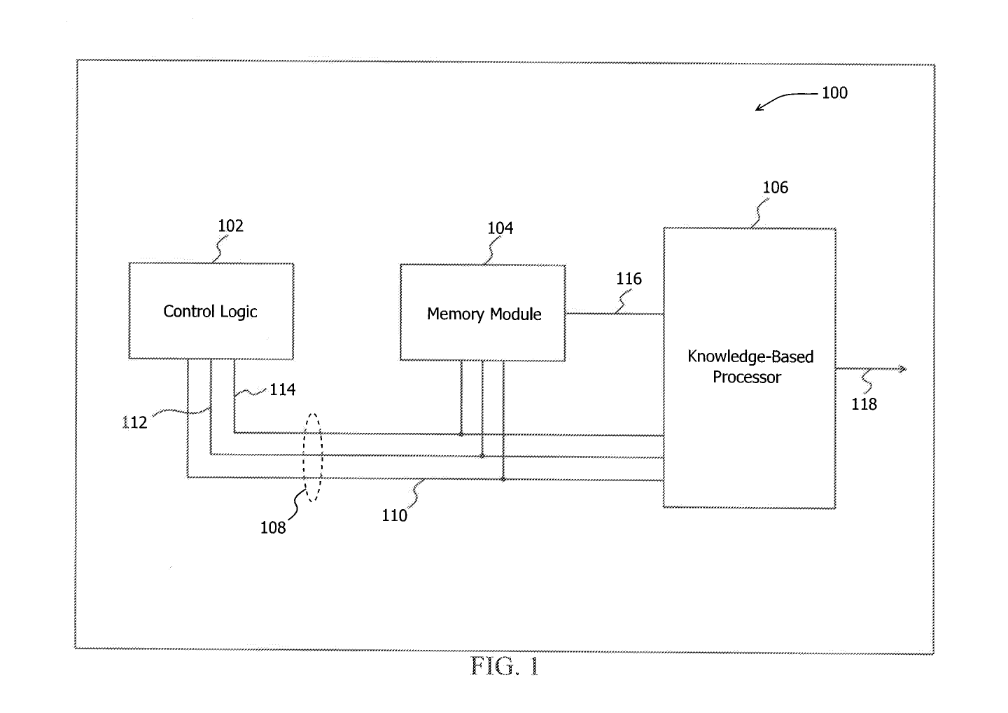

FIG. 1 illustrates a block diagram of a content aware block power savings architecture 100 according to an exemplary embodiment of the present disclosure. Content-aware block power savings architecture 100 includes control logic block 102, memory module 104, and knowledge-based processor (KBP) module 106.

Control logic block 102 communicates, controls, and sends instructions and data to memory module 104 and KBP module 106. Control logic block 102 can be implemented as a processor, an application specific integrated circuit (ASIC), a complex programmable logic device (CPLD), and/or a field programmable gate array (FPGA), for example, or any portion or combination thereof. Control logic block 102 can be implemented as any combination of software and/or hardware as would be appreciated by a person of ordinary skill in the art.

Control logic block 102 is coupled to control bus 108 which can include any number of data, instruction, and control buses. Control bus 108 includes, for example, instruction bus 110, data bus 112, and search key bus 114. Control logic block 102 sends data to be stored by memory module 104 and/or KBP module 106 via data bus 112. Similarly, control logic block 102 sends memory operation instructions, such as read, write, and compare, for example, to memory module 104 and/or KBP module 106 via instruction bus 110. Control logic block 102 can additionally send search key data to memory module 104 and/or KBP module 106 via search key bus 114.

KBP module 106 is coupled to control bus 108, block-enable line 116, and forwarded data bus 118. KBP module 106 can be configured as an array of content-addressable memory (CAM), or ternary content addressable memory (TCAM), for example. KBP module 106 is configured to read and store data sent by control logic block 102, and to process and/or perform operations such as read, write, and compare, on the stored data. When performing a compare operation, KBP module 106 compares stored data to a search key provided via search key bus 114. KBP module 106 compares the entire contents of stored data within a CAM or TCAM block to the search key virtually simultaneously. In this way, KBP module 106 provides additional information associated with the stored data matching the search key via forwarded data bus 118.

In an embodiment of the present disclosure, KBP module 106 performs a compare operation when the block-enable line 116 is asserted. Otherwise, KBP module 106 does not perform the requested compare operation. In this way, block-enable line 116 serves to override the compare operation instructions from control logic block 102. Because KBP module 106 uses a significant amount of power when performing a compare operation, disabling the compare operation of KBP module 106, under certain conditions, can result in significant power savings.

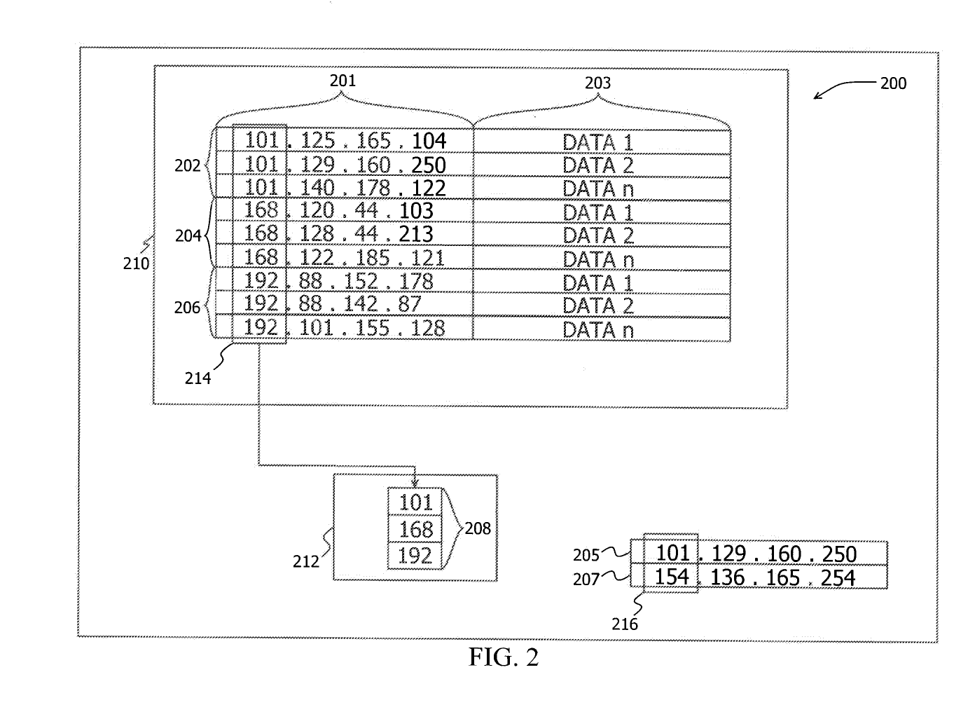

In an embodiment of the present disclosure, KBP module 106 stores data received from control logic block 102 as multiple entries in a CAM or a TCAM array table. Referring to the example shown in FIG. 2, KBP module 106 is configured to store data received from control logic block 102 as data entries 202, 204, and 206 in an array block 210. Upon receipt of a compare instruction, KBP module 106 compares a portion of the search key with the compare instructions received from the control logic block 102 to data entries 202, 204, and 206 and provides any portion of the data 1 through data n, corresponding to a matched data entry on the forwarded data bus 118.

KBP module 106 is coupled to memory module 104 via block-enable line 116. Memory module 104 is further coupled to control logic block 102 via control bus 108. Memory module 104 is configured to read and store data sent by control logic block 102, and to process and/or perform operations on the stored data. In an embodiment, memory module 104 stores a portion of the data stored in a CAM or a TCAM array table of KBP module 106.

The memory module 104 can be implemented, for example, as a lookup table (LUT) constituting static or dynamic random access memory coupled to control logic, any number of processors, any number of address counters, and/or any number of address decoders, to carry out operations on the data sent via the control bus 108 and/or data stored in the memory module 104. In an embodiment of the present disclosure, the data stored in the CAM or TCAM of the KBP module is truncated prior to storage in the LUT. For example, referring to FIG. 2, as the data entries are stored in the CAM or TCAM array block 210, the same data entries stored in truncated form as data entries 208 in a LUT implemented as a memory array block 212. When a compare operation instruction is received, memory module 104 is configured to compare a portion of a search key received with the instruction to the data entries 208, and either allow or prevent KBP module 106 from performing compare operations for that particular search key.

Memory module 104 enables or disables KBP module 106 from performing a compare operation utilizing a control signal sent over block-enable line 116. The control signal can be a logic-level voltage, for example. Memory module 104 sets block-enable line 116 to enabled if a match is found between the truncated data stored in the memory module 104 and a portion of the search key used for a compare operation, indicating that data may be stored in the KBP module. The assertion of block-enable line 116 allows the KBP module to perform compare operations. If a match is not found indicating data is not stored in the KBP module for that search key, block-enable line 116 is not asserted. If block-enable line 116 is not asserted, KBP module 106 is prevented from performing compare operations. Compare operations performed at KBP module 106 are therefore prevented when memory module 104 determines that data associated with the search key is not stored in KBP module 106. As a result, power savings is achieved by avoiding unnecessary compare operations.

According to embodiments of the present disclosure, memory module 104 operates in conjunction with KBP module 106, or independently having any, some, or all of the functionality of KBP module 106. Any portion of either memory module 104 or KBP module 106 can be integrated together to provide an independently operating memory module. Memory module 104 can be implemented as any combination of software and/or hardware that will be apparent to those skilled in the relevant art(s) to carry out the memory operations as described herein without departing from the spirit and scope of the disclosure.

According to embodiments of the present disclosure, KBP module 106 includes a plurality of CAM and/or TCAM array blocks, and these CAM and/or TCAM array blocks have separate or shared block-enable lines. Memory module 104 is configured to include any number of separate or integrated memory modules having a separate or a shared block-enable line. In this way, different CAM and/or TCAM array blocks within KBP module 106 are controlled by any combination of memory modules constituting memory module 104. Consequently, KBP module 106 is configured with CAM and/or TCAM array blocks having their respective compare operations disabled by any combination of the memory modules constituting memory module 104, which allows for flexibility in the design of the content-aware block power savings architecture 100.

As discussed above, FIG. 2 illustrates an example of data stored in memory module 104 and KBP 106. Data 200 includes memory array block 210 and truncated memory array block 212. Memory array block 210 represents an exemplary embodiment of an array block within KBP module 106. The truncated memory array block 212 represents an exemplary embodiment of an array block within memory module 104. The decimal equivalents of network addresses 201, network data 203, truncated data entries 208, and search keys 205 and 207 would ordinarily be stored in memory module 104 in binary, and not decimal form, but are illustrated in decimal form for reference and clarity in FIG. 2.

Memory array block 210 stores data received from control logic block 102, which includes network addresses 201 and corresponding network data 203. Data entries 202, 204, and 206, which represent network addresses. Data entries 202 share the same most significant byte (MSB) ‘101,’ data entries 204 share the same MSB ‘168,’ and data entries 206 share the same MSB ‘192.’ Although the network addresses are stored sequentially by common MSB groupings in FIG. 2, the data stored in memory array block 210 could be stored in any order, or spread across several CAM and/or TCAM blocks within KBP module 106.

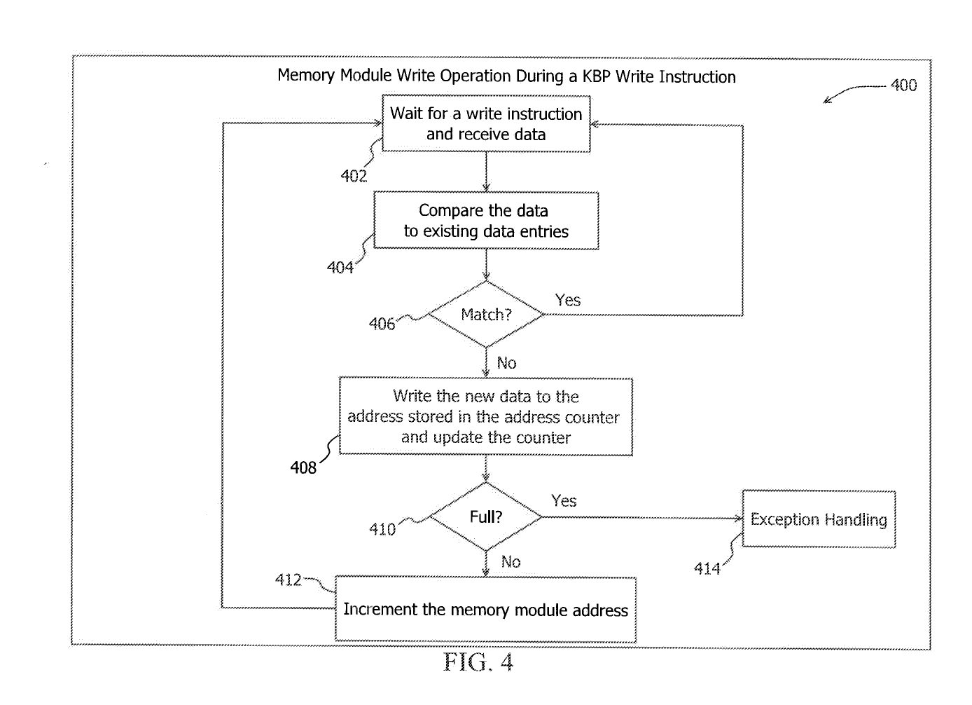

The truncated memory array block 212 of memory module 104 stores a truncated portion of each of the network addresses 201 stored by the KBP module 106. FIG. 4 below describes the write process utilized by memory module 104 in further detail. For example, memory module 104 only contains entries for the MSBs ‘101,’ ‘168,’ and ‘192.’ When a compare instruction is received, memory module 104 compares the data entries 208 to a portion of a search key. FIG. 2 provides examples of two search keys 205 and 207 having an MSB 216. Without the memory module 104, the entirety of the search keys 205 and 207, or a portion of the search keys 205 and 207 greater than the MSB 216, would be compared in the memory array block 210 of the KBP to each of network addresses 201 stored as the data entries 202, 204, and 206.

In embodiments of the present disclosure, an initial compare operation is performed in memory module 104 using a LUT. During this operation, a comparison of a portion of the search key to each of the data entries 208 is performed. If a match is found, such as for search key 205, for example, memory module 104 asserts the block-enable line 116 to cause KBP module 106 to perform a compare operation. If a match is not found, such as for search key 207, for example, memory module 104 de-asserts block-enable line 116 to prevent KBP module 106 from performing a compare operation. KBP module 106 performs compare operations for only those search keys that match a data entry in the truncated array. KBP module 106 therefore performs compare operations for only those search keys that match a data entry in the truncated array. Thus, the KBP module is prevented from performing a compare operation when the network address in the search key does not exist in the memory array block 210.

Although MSB 214 of network addresses 201 is used in the example provided in FIG. 2, any portion of a network address stored by memory array block 210 could be stored in memory array block 212. Using MSB 214 as the truncated portion of network addresses 201 allows for a maximum of 256 unique comparisons to be made. However, in an application which requires more or less unique entries, due to the size of the network, for example, the truncated portion of network addresses 201 and search keys 205 and 207 could be a larger or smaller bit string than MSBs 214 and 216.

In an embodiment of the present disclosure, memory array block 210 and truncated memory array block 212 are configured as part of a single integrated independent array block as part of a single integrated device. KBP module 106 is configured as any number of CAM or TCAM array blocks with portions thereof, such as memory array block 210, for example, allocated for high-speed simultaneous comparisons. In such a configuration, the remainder of the CAM or TCAM array blocks is allocated as a LUT, such as truncated memory array block 212, for example.

In an embodiment of the present disclosure, an integrated device including both memory array block 210 and truncated memory array block 212 can store a global mask received from control logic block 102 in a dedicated register. This dedicated register is accessible by both memory array block 210 and truncated memory array block 212. In this way, memory array block 210 quickly overwrites old data entries with new data entries as network addresses 201 by changing only the necessary bits as indicated by the global mask. Furthermore, the truncated memory array block 212 stores and compares the appropriate portion of the search key according to the global mask. Depending on the space required in memory array block 210 for a particular application, more or less space can be allocated between memory array block 210 and truncated memory array block 212 to improve power savings.

Although FIG. 2 is illustrated using network IP addresses, memory array block 210 and truncated memory array block 212 are configured to store data of any type. To provide an example, although the IP network addresses shown in FIG. 2 are IPv4 network addresses, IPv6 network addresses could also be stored. In such an example, the truncated portion stored in the truncated memory and the truncated portion of the search key used for a comparison could be a most significant hexadecimal word. To provide another example, memory array block 210 and truncated memory array block 212 can store and compare any portions of processor cache data to provide a corresponding cache tag.

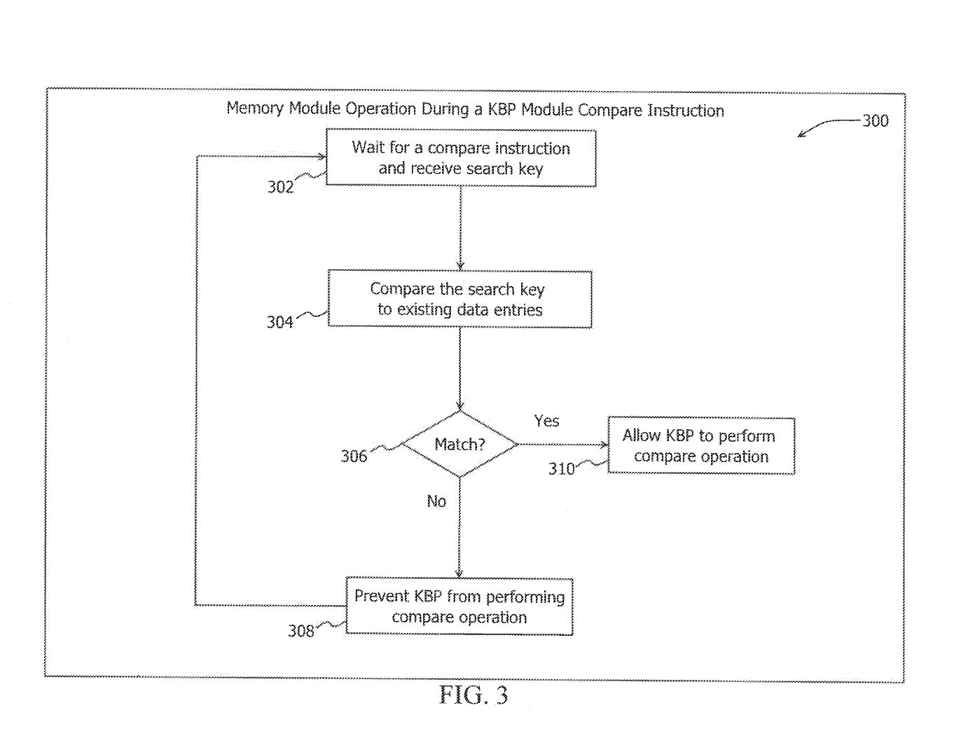

FIG. 3 is a flowchart 300 of a method for performing a memory module compare operation according to an exemplary embodiment of the invention. Flowchart 300 is described with reference to the embodiments of FIGS. 1 and 2. However, flowchart 300 is not limited to those embodiments.

Prior to step 302, memory module 104 is in an idle state. Upon receipt of a compare instruction, memory module 104 selects a portion of the search key from the search key received over search key bus 114.

In step 304, the memory module compares the portion of the search key to the other data entries stored in memory module 104. Memory module 104 stores a truncated version of the data stored in KBP module 106, and truncated portions of the data and the search key are compared. If the search key does not match a data entry among the truncated data entries 208, then the data will likewise not be found in the data entries stored in KBP module 106.

In step 306, a determination is made whether a match is found. If a match is found, operation proceeds to step 310. If no match is found, operation proceeds to step 308.

In step 308, memory module 104 de-asserts block-enable line 116. The de-assertion of block-enable line 116 prevents KBP module 106 from performing a compare operation between search key 205 and data entries 202, 204, and 206 stored in KBP module 106.

In step 310, memory module 104 asserts block-enable line 116. This allows KBP module 106 to perform a compare operation between search key 205 and data entries 202, 204, and 206 stored in KBP module 106.

The memory module 104 therefore compares a portion of the data entries stored in KBP module 106 to a portion of the search key to determine whether the search key could be stored in KBP module 106. If memory module 104 determines the search key cannot be stored in KBP module 106, then memory module 104 prevents KBP module 106 from performing a needless comparison operation. By preventing compare operations at KBP module 106 when there is no need to perform them, content-aware block power savings architecture 100 saves power wasted by performing needless compare operations.

FIG. 4 is a flowchart 400 of a method for performing a memory module write operation according to an embodiment of the present disclosure. Flowchart 400 is described with reference to the embodiments of FIGS. 1 and 2. However, flowchart 400 is not limited to those embodiments.

Prior to step 402, memory module 104 is in an idle state waiting for control logic block 102 to send data to KBP module 106 via data bus 112.

In step 402, data sent by control logic block 102 is received by memory module 104 and stored, in a buffer or memory register, for example. Memory module 104 stores all or part of the data sent to KBP module 106 as truncated data entries 208. Partial or truncated data stored by memory module 104 can be a portion of a larger data string stored by KBP module 106.

In step 404, the memory module 104 compares the received data to the other data entries stored in the memory module. Because the memory module 104 stores a smaller amount of data compared to the KBP module 106, control logic within the memory module 104 utilizes a sequential search routine, for example, to find a match between the received data and any of the truncated data entries 208. In an embodiment of the present disclosure, memory module 104 can be a TCAM, which would improve the search speed during a write and/or a compare operation.

In step 406, memory module 104 determines whether the received data matches one of the truncated data entries 208. The truncated data entries 208 are condensed such that each data entry is unique. In this way, only received data not currently stored among the truncated data entries 208 is added to the truncated data entries 208. If a match is found, operation returns to step 402, received data will not be stored among the truncated data entries 208, and only KBP module 106 will be updated with the entry. If a match is not found, operation proceeds to step 408.

In step 408, memory module 104 stores the received MSB by adding the data to the truncated data entries 208. To determine whether the memory module has sufficient storage to store the data among the truncated data entries 208, memory module 104 is configured to utilize an address counter. The address counter provides a range of addresses where memory module 104 is capable of storing the truncated data entries 208. Provided the address counter has not exceeded the range of storage available, the received data is stored among truncated data entries 208, and in a parallel operation, KBP module 106 is simultaneously updated with the data entry. Once the received data is stored, the address counter is updated to indicate where to store the next received data sent by control logic block 102.

In step 410, memory module 104 polls the address counter to determine whether there is memory space available to store an additional data entry as part of the truncated data entries 208. If sufficient memory exists, operation proceeds to step 412. If sufficient memory does not exist, operation proceeds to step 414.

In step 412, the memory module address is incremented if the address counter indicates that additional addresses are available to store subsequent data. Once the address of the memory module 104 is incremented to the address to store the next data, the processing returns to step 302.

In step 414, memory module 104 utilizes exception handling routines to guarantee KBP module 106 continues to operate and perform compare operations only when necessary. If the address counter indicates that the data has filled all available space and no more subsequent data can be added to the truncated data entries 208, memory module can implement several exception handling techniques according to various embodiments of the present disclosure.

In an embodiment of the present disclosure, memory module 104 can prioritize the block-enable line as part of an exception handing routine in step 414. When no additional memory space is available in memory module 104, new data which would need to be added to the truncated data entries 208 could be a part of the data stored in KBP module 106. KBP module 106 needs to perform compare operations sent by control logic block 102 for this new data. Therefore, memory module 104 can override a previous state of block-enable line 116 and continue to assert block-enable line 116 to allow compare operations at KBP module 106 while no additional memory is available for new data entries.

In another embodiment of the present disclosure, memory module 104 controls memory storage as part of an exception handing routine in step 414. To control memory storage, memory module 104 is configured to “flush” and/or rewrite any, some, or all of the truncated data entries 208 after a programmable and/or a predetermined amount of time or depending on any number of conditions, and reset the address counter accordingly. Memory module 104 determines which of the truncated data entries 208 are most often matched, for example, and prioritizes those data entries over others stored among the truncated data entries 208. According to this prioritization, more often matched truncated data entries 208 are saved longer while less matched truncated data entries 208 are flushed or rewritten sooner. In this way, the memory module 104 increases the time in which KBP module 106 does not need to perform compare operations to improve overall power savings.

In another embodiment of the present disclosure, in step 414, control logic block 102 scans KBP module 106 and memory module 104 and compares respective portions of the data entries stored in each. If stale or deleted entries are found in KBP module 106 which remain stored in memory module 104, control logic block 102 can subsequently flush these corresponding data entries. Control logic block 102 can perform scan and delete operations to free up storage in memory module 104 as a background operation during idle cycles.

In yet another embodiment of the present disclosure, memory module 104 compacts data entries to conserve memory as part of an exception handing routine in step 414. To compact the data entries, memory module 104 is configured to run a compaction routine and/or algorithm to compact truncated data entries 208 to take up less memory.

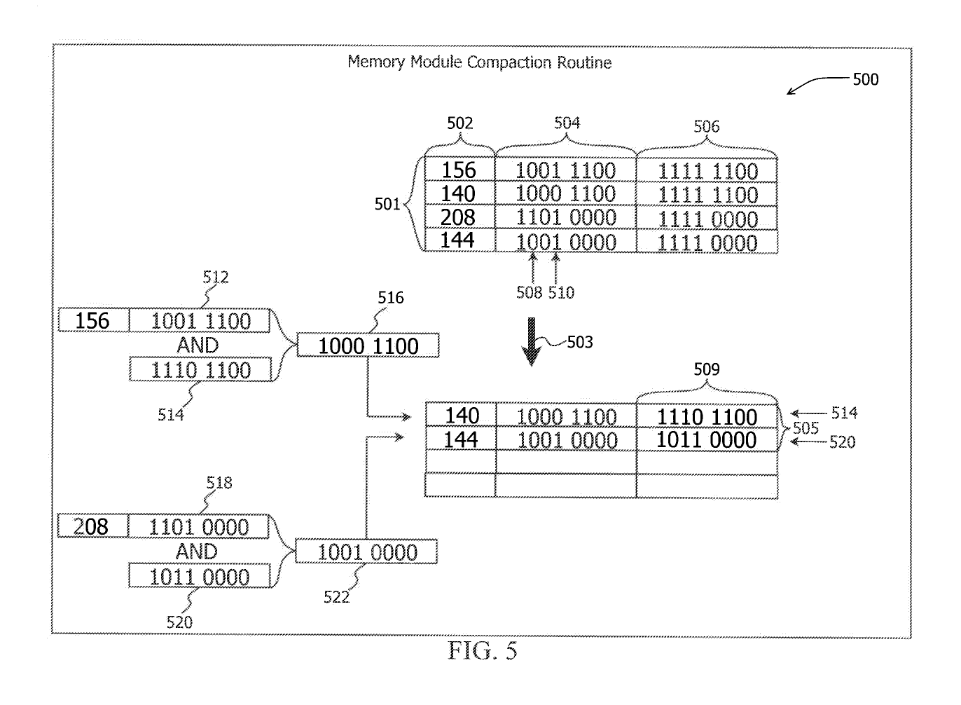

FIG. 5 illustrates the result of a compaction routine 500 in accordance with an embodiment of the invention. Compaction routine 500 is described with reference to the embodiments of FIGS. 1 and 2. However, compaction routine 500 is not limited to those embodiments. Compaction routine 500 includes a compaction routine step 503 to compact the data entries 501 to the compacted data entries 505. Data entries 501 can represent an exemplary embodiment of the truncated data entries 208. The decimal equivalents 502 of the data entries 501 would ordinarily be stored in the memory module 104 in binary form, but are provided for reference and clarity in FIG. 5. Data entries 501 include data 504 along with continuous local mask 506. Continuous local mask 506 is used by memory module 104 to organize the data entries and hasten the matching process.

Continuous local mask 506 is generated by memory module 104 to include a byte having a continuous string of ones followed by zeroes such that the trailing zeroes match up to the trailing zeroes of a corresponding data entry. In this way, a new data entry received by memory module 104 is quickly matched to other data entries sharing the same continuous local mask 506, rather than memory module 104 searching all of data entries 501 in a sequential and/or serial manner one by one. In the case where a local mask is generated corresponding to a data entry that does not match a continuous local mask 506, memory module 104 can perform an individual search of data entries 501 as a secondary operation.

To perforin the compaction routine step 503, the memory module 104 is configured to make the data entries ternary. That is, memory module 104 can modify continuous local masks 506 to create arbitrary local masks 509, which include a non-continuous string of ones and zeroes. For example, data entry ‘156’ and data entry ‘140’ both have an identical continuous local mask corresponding to ‘1111 1100.’ Memory module 104 is configured to change this continuous local mask to arbitrary local mask 514 corresponding to ‘1110 1100,’ by zeroing out a bit corresponding to bit 510, which represents the only difference between the data entries ‘156’ and ‘140.’ Similarly, memory module 104 changes the continuous local mask ‘1111 0000’ to arbitrary local mask 520 corresponding to ‘1011 0000’ by zeroing out a bit corresponding to bit 508, which represents the only difference between data entries ‘208’ and ‘144.’

By changing continuous local masks 506 to arbitrary local masks 509, memory module 104 saves half the memory space used by compacted data entries 505 compared to the memory space used by data entries 501. Although data entries ‘156’ and ‘208’ are no longer specifically stored in memory module 104, memory module 104 still verifies a match by comparing a new data entry received from the control logic block 102 in a ternary fashion. For example, memory module 104 first performs an AND operation between data entry 512 received from control logic block 102, which includes data represented by ‘156,’ and arbitrary local mask 514. The result of this AND operation results in compare data 516. Compare data 516 matches data entry ‘140’ due to the ternary comparison of new data entry 512 to both arbitrary local mask 514 and the data entry ‘140’ stored in memory module 104.

Similarly, new data entry 518 representing ‘208’ would result in compare data 522 when an AND operation is performed between new data entry 518 and arbitrary local mask 520. Compare data 522 matches the data entry ‘144,’ due to the ternary comparison of new data entry 518 to both arbitrary local mask 520 and data entry ‘144’ stored in memory module 104.

In an embodiment of the present disclosure, memory module 104 is configured run the compaction routine at any time. For example, the memory module can run the compaction routine after the address counter indicates the memory module has run out of addressable memory space to store new data entries. To provide another example, the memory module can run the compaction routine during idle cycles, i.e., when waiting for new data to be sent from control logic block 102 prior to step 302. If the compaction routine occurs at a time when memory module 104 cannot store and/or is unable to process additional data entries, memory module 104 can override the state of block-enable line 116 to allow KBP module 106 to continue to perform compare operations.

The disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It will be apparent to those skilled in the relevant art(s) that various changes in form and detail can be made therein without departing from the spirit and scope of the disclosure. Thus the disclosure should not be limited by any of the above-described exemplary embodiments, but should be defined only in accordance with the following claims and their equivalents.

Embodiments of the invention can be implemented in hardware, firmware, software, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

What is claimed is:

1. A memory system, comprising:
a first memory configured to store a plurality of addresses and associated data; and
a second memory configured to store truncated versions of the plurality of addresses;
wherein, upon receipt of a compare instruction and a search key, the second memory compares the truncated versions of the plurality of addresses to a truncated version of the search key and provides an enable signal to the first memory is a match is found, and
wherein, upon receipt of the compare instruction, the search key, and the enable signal, the first memory compares the plurality of addresses to the search key to access the data associated with the address.

2. The memory system of claim 1, wherein the second memory is further configured to generate the enable signal having a logic high or a logic low state.

3. The memory system of claim 2, wherein the second memory is further configured to set the enable signal to either the logic high or the logic low state when any of the truncated versions of the plurality of addresses matches the truncated version of the search key.

4. The memory system of claim 2, wherein the second memory is further configured to set the enable signal to either the logic high or the logic low state when any of the truncated versions of the plurality of addresses do not match the truncated version of the search key.

5. The memory system of claim 1, wherein the second memory is further configured to store unique truncated versions of the plurality of addresses.

6. The memory system of claim 2, wherein the second memory is further configured to generate the enable signal to allow the first memory to compare the plurality of addresses to the search key when the second memory is incapable of storing additional truncated versions of the plurality of addresses.

7. The memory system of claim 1, wherein the second memory is further configured to compact the truncated versions of the plurality of addresses in a ternary manner according to a plurality of masks.

8. The memory system of claim 1, wherein the second memory is further configured to compact the truncated versions of the plurality of addresses during an idle cycle time.

9. The memory system of claim 1, wherein the plurality of addresses and the search key are internee protocol (IP) addresses, and wherein the truncated portions of the plurality of addresses and the search key are the most significant bytes (MSBs) of respective IP addresses.

10. The memory system of claim 1, wherein the memory system is coupled to a networking device.

11. A memory system, comprising:
a content addressable memory (CAM) configured to store data; and
a memory coupled to the CAM, the memory configured to store a truncated subset of the data stored in the CAM, to compare the truncated subset of data to a truncated portion of a search key, and to disable a CAM operation when no match is found between the truncated portion of the search key and the truncated subset of data.

12. The memory system of claim 11, wherein the CAM operation is a compare operation between the data stored in the CAM and the search key.

13. The memory system of claim 11, wherein the memory is further configured to store unique data entries as the truncated subset of data.

14. The memory system of claim 11, wherein the data stored in the CAM and the search key are internee protocol (IP) addresses, and wherein the truncated subset of data and the truncated portion of the search key are the most significant bytes (MSBs) of the IP addresses.

15. The memory system of claim 11, wherein the memory system is coupled to a networking device.

16. In a memory module having a first memory storing a plurality of addresses and a second memory storing truncated portions of the plurality of addresses, a method comprising:
receiving, by the second memory, a compare instruction and a search key;
comparing, by the second memory, the stored truncated portions to a portion of the search key;
generating, by the second memory, an enable signal when a match is found between the truncated portions and the portion of the search key; and
comparing, by the first memory, the plurality of addresses to the search key upon receiving the compare instruction, the search key, and the enable signal.

17. The method claim 16, wherein the stored truncated portions of the plurality of addresses step are most significant bytes (MSBs) of the plurality of addresses, and wherein the step of comparing by the first memory comprises:
comparing the stored truncated portions to an MSB of the search key.

18. The method claim 16, wherein the stored truncated portions of the plurality of addresses step are most significant hexadecimal words of the plurality of addresses, and wherein the step of comparing by the first memory comprises:
comparing the stored truncated portions to a most significant hexadecimal word of the search key.

19. The method of claim 16, further comprising:
controlling, by the second memory, a memory operation of the first memory or the second memory based on mask registry information.

20. The method of claim 16, wherein the step of generating comprises:
generating the enable signal having a logic high or a logic low state.
